(19) United States
(12) Patent Application Publication
(10) Pub. No.: US 2013/0346306 A1
(43) Pub. Date: Dec. 26, 2013

(54) SYSTEMS AND METHODS FOR INCENTIVIZING A MERCHANT IN A PREPAID DEBIT CARD SYSTEM

(71) Applicant: Phillip Kopp, Sao Paulo (BR)

(72) Inventor: Phillip Kopp, Sao Paulo (BR)

(21) Appl. No.: 13/925,701

(22) Filed: Jun. 24, 2013

Related U.S. Application Data
(60) Provisional application No. 61/663,445, filed on Jun. 22, 2012.

(51) Int. Cl. G06Q 20/34; G06Q 30/02

(52) U.S. Cl. CPC G06Q 20/34; G06Q 30/0222
USPC 705/41

(57) ABSTRACT

Systems and methods for facilitating the promotion and sale of prepaid debit cards in the retail outlets of non-bank merchants. In an embodiment, prepaid debit cards are consigned, rather than sold, to the merchants. Furthermore, a lifetime commission may be provided to the merchants to encourage promotion of the prepaid debit cards. Through the motivated promotion of prepaid debit cards, under-banked or un-banked consumers can be encouraged to experience the security and flexibility of the banking system without being part of the banking system. In some circumstances, these consumers may be guided into the banking system.

### PRIORITY

This application claims the benefit of U.S. Provisional Patent App. No. 61/663,445, entitled “Systems and Methods for Incentivizing a Merchant in a Prepaid Debit Card System” and filed on Jun. 22, 2012, the entirety of which is hereby incorporated herein by reference as if set forth in full.

### FIELD OF THE INVENTION

The systems and methods disclosed herein relate generally to the facilitation of prepaid debit card transactions.

### BACKGROUND

In many countries, a significant portion of the population is un-banked or under-banked. This un-banked portion of the population does not have access to an account at a financial institution, such as a checking, savings, or credit account. These individuals also lack use of credit and debit cards, electronic funds transfers (EFT), and the like to facilitate transactions. In Brazil, it is estimated that the under-banked population comprises approximately 133 million individuals. The un-banked population comprises approximately 29 million individuals.

These individuals may not be un-banked or under-banked by choice. For instance, many of these individuals may not meet the requirements (e.g., credit rating, credit or banking history, etc.) imposed by banks for issuance of a bank account or credit. In some countries, where retail banking services have low penetration, a large portion of the population may not even have access to a bank.

This can be especially problematic for online transactions (e.g., Internet-based transactions), such as purchases from ecommerce sites. Many Internet sites do not support cash purchases or, at the very least, do not make it easy to complete cash purchases.

In addition, the un-banked population lacks the security that accompanies the use of the banking system. For instance, these individuals must maintain their cash in relatively insecure locations, such as their homes. Furthermore, in order to make a purchase, they must physically carry the cash, for example, in a pocket, wallet, or purse. In doing so, they expose the cash to possible theft, destruction, or other loss. Unlike a credit or debit card, which can be replaced in the event of loss, cash is irreplaceable if lost.

Un-banked or under-banked individuals also lack the convenience of income and expense tracking and management tools provided by financial systems.

Prepaid debit cards and/or “digital wallets” (i.e., mobile-application-based electronic transactions) are a potential solution to these problems. An individual can exchange cash for a plastic debit card or digital wallet application associated with the value of the cash exchanged (minus any fees, if applicable). The seller or issuer of the card or a third party associated with the seller or issuer of the card can hold the cash in a secure location (e.g., a financial institution such as a bank). The individual can then use the prepaid debit card just like any other debit card or credit card to make purchases, including online purchases. If the card is stolen, destroyed, or otherwise lost, it can be easily replaced with a new debit card associated with the prepaid cash value remaining on the card prior to the loss.

However, several barriers exist to widespread adoption of prepaid debit cards. For instance, some financial institutions sell prepaid debit cards through bank outlets. However, these cards are only sold through the institution's banking locations. These outlets are unable to capture individuals who are not already in the retail banking system, since such individuals are unlikely to visit banking locations where the cards are sold. Simply put, financial institutions do not have the infrastructure to reach un-banked populations. For example, in Brazil, the combined number of retail bank outlets is approximately 13,500, whereas the number of untapped non-bank retail outlets is in the hundreds of thousands.

Prepaid wireless cards have made inroads into the non-bank retail market. For instance, merchants, such as convenience stores, will purchase a set of prepaid wireless cards. The merchant will then sell the wireless cards at a mark-up in order to collect a profit on the sales. Customers who purchase such cards can reload them into a compatible wireless phone, and use the phone for the number of calling minutes specified as the face value of the wireless card.

However, the prepaid wireless card model is not conducive to the sale of prepaid debit cards. Merchants are not willing to make the expenditure required to purchase lots or sets of prepaid debit cards. Whereas a 1,000 minute prepaid wireless card may cost a merchant $30, a $1,000 prepaid debit card would likely cost a merchant $1,000. This is a hefty expenditure for a merchant to make. Furthermore, the markups cannot be as high for prepaid debit cards as for prepaid wireless cards. For example, whereas the merchant may be able to sell a 1,000 minute prepaid wireless card for $40 (i.e., a 33% markup), the merchant would likely not be able to sell the $1,000 prepaid debit card for a 33% markup (i.e., $1,333). A consumer who purchases a prepaid debit card is immediately aware of how much the markup is, since it is simply the difference between the amount that the consumer has to pay for the card and the amount that is available for use on the card (i.e., the prepaid deposit amount). If the markup is too high, the consumer will simply choose to continue using cash, rather than paying a fee for the convenience of a debit card.

Accordingly, financial institutions do not have the reach to make prepaid debit cards successful, and merchants do not have the incentive to make prepaid debit cards successful.

### SUMMARY

Accordingly, disclosed herein are systems and methods for facilitating and incentivizing the promotion and sale of prepaid debit cards at points of sale in non-bank retail locations, such as pharmacies, grocery stores, convenience stores, gas stations, and the like.

In an embodiment, a method for managing prepaid debit cards is disclosed. The method comprises consigning one or more prepaid debit cards to a merchant, receiving transaction information comprising data related to one or more purchase transactions or other fee-based transactions in which the one or more prepaid debit cards were used, and providing an incentive to the merchant based on the received transaction information. In an embodiment, this incentive, which can be a percentage or a fixed fee, can vary based on one or more of: a volume of a plurality of purchase transactions in which the one or more prepaid debit cards were used, a total value of deposits (e.g., reloads) to accounts associated with the one or more prepaid debit cards, and a volume of new accounts generated for, or otherwise associated with, the one or more prepaid debit cards (e.g., by the merchant and/or purchasers of the one or more prepaid debit cards). Furthermore, in an additional or alternative embodiment, the merchant can be activated or deactivated (e.g., enabled/disabled from selling or collecting reload deposits for prepaid debit cards and/or otherwise participating in the incentive program) depending on whether or not the merchant has exceeded an associated credit limit.

In an additional embodiment, a system for managing prepaid debit cards is disclosed. The system comprises at least one executable software module that receives an association between one or more prepaid debit cards and a merchant, receives transaction information comprising data related to one or more purchase or fee-based transactions in which the one or more prepaid debit cards were used, and determines a commission amount of the merchant based on the association and the received transaction information.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is an illustration of an example system that may be used to perform at least a portion of the disclosed process, according to an embodiment;

FIG. 2 is an illustration of an example terminal for promoting, selling, and reloading prepaid debit cards, according to an embodiment;

FIG. 3A is an illustration of an authorization system, according to an embodiment;

FIG. 3B is an illustration of a back-office system, according to an embodiment;

FIG. 4A is an illustration of an authorization network, according to an embodiment;

FIG. 4B is an illustration of a back-office network, according to an embodiment;

FIG. 5 is an illustration of a program management and transaction process on a scalable technology platform, according to an embodiment;

FIG. 6 is an illustration of a monetary model, according to an embodiment;

FIGS. 7A and 7B are a comparison of a disclosed collections model to a conventional collections model, according to an embodiment; and

FIG. 8 is an illustration of an example computing device which can be used in conjunction with the disclosed systems and processes, according to an embodiment.

### DETAILED DESCRIPTION

System Overview

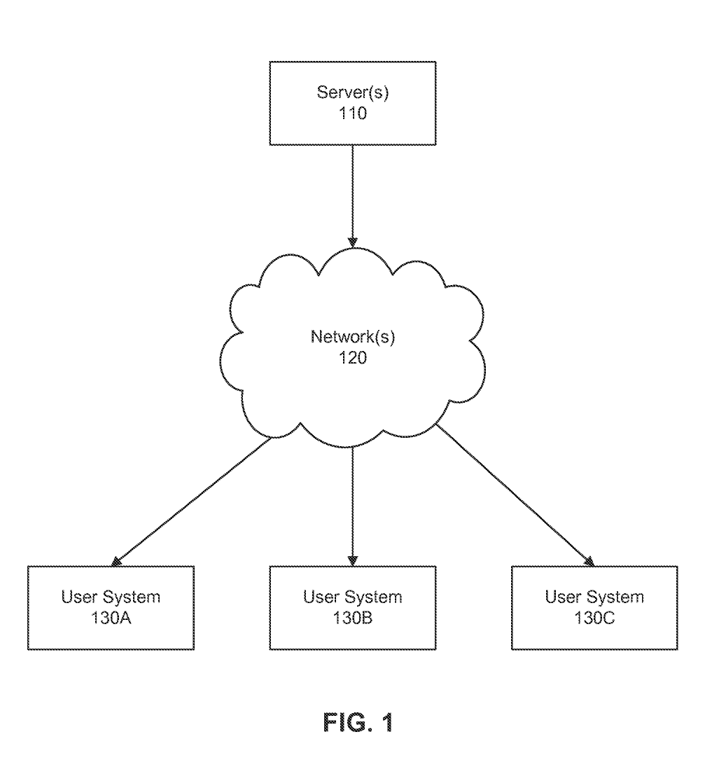

FIG. 1 illustrates an example system for managing prepaid debit cards, according to an embodiment. The system may comprise a set of one or more servers 110 which host and/or execute one or more of the various functions, processes, and/or software modules described herein. In addition, server(s) 110 are communicatively connected to one or more user systems 130 via one or more network(s) 120. Network(s) 120 may comprise the Internet, and server(s) 110 may communicate with user system(s) 130 through the Internet using standard transmission protocols, such as HyperText Transfer Protocol (HTTP), Secure HTTP (HTTPS), File Transfer Protocol (FTP), FTP Secure (FTPS), SSH FTP (SFTP), and the like, as well as proprietary protocols. In an embodiment, server(s) 110 may not be dedicated servers, and may instead be cloud instances, which utilize shared resources of one or more servers. Furthermore, while server(s) 110 are illustrated as being connected to various systems through a single set of network(s) 120, it should be understood that the server(s) 110 may be connected to the various systems via different sets of one or more networks. For example, server(s) 110 may be connected to a subset of user systems 130 via the Internet, but may be connected to one or more other user systems 130 via an intranet. It should also be understood that user system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale (POS) terminals, Automated Teller Machines, and the like. These computing devices may be operated by merchants and/or consumers. In addition, while only a few user systems 130 and one set of server(s) 110 are illustrated, it should be understood that the network may comprise any number of user systems and sets of server(s).

Server(s) 110 may comprise web servers which host one or more websites or web services. In embodiments in which a website is provided, the website may comprise one or more user interfaces, including, for example, webpages generated in HyperText Markup Language (HTML) or other language. Server(s) 110 transmit or serve these user interfaces in response to requests from user system(s) 130. In some embodiments, these user interfaces may be served in the form of a wizard, in which case two or more user interfaces may be served in a sequential manner, and one or more of the sequential user interfaces may depend on an interaction of the user or user system with one or more preceding user interfaces. The requests to server(s) 110 and the responses from server(s) 110, including the user interfaces, may both be communicated through network(s) 120, which may include the Internet, using standard communication protocols (e.g., HTTP, HTTPS). These user interfaces or web pages may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (not shown) that are locally and/or remotely accessible to the server(s) 110. Server(s) 110 may also respond to other requests from the user system(s) 130.

Server(s) 110 may further comprise, be communicatively coupled with, or otherwise have access to one or more database(s). For example, server(s) 110 may comprise one or more database servers which manage one or more databases. A user system 130 or application executing on server(s) 110 may submit data (e.g., user data, form data, etc.) to be stored in the database(s), and/or request access to data stored in such database(s). Any suitable database may be utilized, including without limitation MySQL, Oracle, IBM, Microsoft SQL, Sybase, Access, and the like, including cloud-based database instances. Data may be sent to the server(s) 110, for instance, using the well-known POST request supported by HTTP, via FTP, etc. This data, as well as other requests, may be handled, for example, by server-side web technology, such as a servlet or other software module, executed by the server(s) 110.

In embodiments in which a web service is provided, server(s) 110 may receive requests from user system(s) 130, and provide responses in eXtensible Markup Language (XML) and/or any other suitable or desired format. In such embodiments, server(s) 110 may provide an application programming interface (API) which defines the manner in which user system(s) 130 may interact with the web service. Thus, user system(s) 130, which may themselves be servers, can define their own user interfaces, and rely on the web service to implement the backend processes, functionality, storage, etc., described herein. For example, in such an embodiment, a client application executing on one or more user system(s) 130 may interact with a server application executing on server(s) 110 to execute one or more or a portion of one or more of the various functions, processes, and/or software modules described herein. The client application may be “thin,” in which case processing is primarily carried out server-side by server(s) 110. A simple example of a thin client application is a browser application, which simply requests, receives, and renders web pages at user system(s) 130, while server(s) 110 are responsible for generating the web pages and managing database functions. Alternatively, the client application may be “thick,” in which case processing is primarily carried out client-side by user system(s) 130. It should be understood that the client application may perform an amount of processing, relative to server(s) 110, at any point along this spectrum between “thin” and “thick,” depending on the design goals of the particular implementation. In any case, the application, which may wholly reside on either the server(s) or user system(s) or be distributed between the server(s) or user system(s), can comprise one or more executable software modules that implement one or more of the processes or functions of the application(s) described herein.

Process Overview

In an embodiment, prepaid debit cards are consigned to merchants, rather than sold to the merchants. The merchant may only be charged a low rate to cover the cost of manufacturing and shipping the cards. In other words, the merchant pays little to no up-front cost for a set of prepaid debit cards. The merchant can then sell the set of prepaid debit cards at the merchant's retail location or locations. The prepaid debit cards may be sold to consumers for a fee, which may accrue to the merchant, the operator of the system, one or more intermediaries or other third parties, or some combination thereof. The fee may be a flat fee (e.g., $2) or a percentage of any prepaid value added to the card (e.g., 2%).

Prepaid debit cards can be distributed in this manner to thousands of merchants and tens of thousands of retail locations through multiple channels, including drug stores, pharmacies, grocery stores, mass merchandisers, convenience stores, gas stations, and the like. Specifically, the sale of prepaid debit cards can be targeted at retail locations which are frequented by individuals in low to medium socioeconomic classes, who are most likely to be un-banked or under-banked. It should be understood that the term “merchant,” as used herein can refer to individual retail locations, a group of retail locations, an electronic commerce (e-commerce) site or other network or Internet site, franchisers, franchisees, a corporate entity, subsidiary, division, or the like, or any other entity or unit which establishes, manages, operates, or is associated with one or more retail locations and/or e-commerce sites.

It should be understood that the prepaid debit cards may comprise any of a variety of well-known technologies, such as magnetic stripes, smart cards, radio-frequency identification (RFID), near field communication (NFC), and the like. Each prepaid debit card can be linked to a transactional bank account, for example, at a bank partner of the operator or program manager. A consumer may be enabled or required to establish a Personal Identification Number (PIN) associated with the prepaid debit card, in order to access services and complete transactions using the card.

In an embodiment, the prepaid debit cards enable consumers who purchase the cards to load and re-load/recharge funds, make purchases, withdraw funds from Automated Teller Machines (ATMs), and the like. The prepaid debit cards may also be associated with other feature-rich products and services, such as Visa™ and/or MasterCard™ acceptance, bill paying, mobile banking applications, transaction notifications (e.g., via email, Short Messaging Service (SMS) text message, etc.), powerful account management tools (e.g., online load options, online financial planners, budgeting tools, online banking, bill pay options, etc.), incentives or reward programs, companion cards, custom cards, refer-a-friend incentives, marketplace discounts, financial literacy, savings accounts, merchant rewards, and the like. In other words, the prepaid debit card is a simple, effective, inexpensive, and efficient financial product that can act as an affordable substitute for checking accounts and credit cards.

In an embodiment, incentives are provided to merchants to encourage them to promote and sell the prepaid debit cards in their retail locations. An incentive can be tied to each prepaid debit card sold and/or reloaded. For instance, an identifier of the merchant who sold a prepaid debit card can be associated with an identifier of the prepaid debit card, e.g., in a database at a central server. All or some of the transactions associated with the prepaid debit card can then be monitored and tracked by software (e.g., via the Internet or other network or combination of networks). These transactions may include the purchase of the card itself, purchases which are paid for using the card, fees associated with using the card, and/or reloads of the card (i.e., the addition of prepaid value to the card or an account associated with the card). The merchant that sells and/or reloads the card can be associated with the card and compensated according to the number or value of the transactions. For example, the merchant may receive a percentage of the value of each purchase made using the card. Alternatively or additionally, the merchant may receive a fixed amount for each purchase made using the card. In this manner, merchants are incentivized to sell and/or reload the prepaid debit cards, since the merchant has the ability to earn a “lifetime commission” for each card sold and/or reloaded, as opposed to a one-time profit margin or commission for selling the card or accepting a reload transaction.

In an embodiment, the incentive to merchants, whether a percentage or fixed amount, can be variable. For instance, the percentage or fixed fee may be determined using tiers or calculated using an algorithm that varies the percentage or fixed amount depending on one or more variables (e.g., input parameters to an algorithm), such as a performance metric associated with the merchant. For instance, these one or more variables may include, without limitation, the volume of purchase transactions associated with cards purchased from the merchant, the total amounts or reloads deposited into accounts associated with cards purchased from the merchant, and/or the volume of new accounts generated by the merchant.

In an embodiment, a software module is provided which tracks the number of cards delivered on consignment to each merchant and the number of cards sold by the merchant. For example, the software module may be hosted on and/or executed by server(s) 110, and receive indications of cards consigned to and/or sold by each merchant via a local input device and/or network(s) 120. The software module may track these indications, and, for each merchant, compare the number of cards consigned to the merchant with the number of cards sold by that merchant to determine whether or not there is a divergence between the two numbers. A divergence between the number of consignments and the number of sales represents an “inventory loss.” In an embodiment, if the software module determines that an inventory loss exists for a merchant, the system can automatically “penalize” the merchant based on the inventory loss. For instance, the system may deduct a fixed value from the incentive owed during the next payment period based on the inventory loss, raise or lower the incentive owed (whether fixed or percentage-based), increase or decrease the period in which incentives are paid, and/or cancel the incentives earned from past card sales.

From the purchase or recharging of a prepaid debit card, a merchant will receive the prepaid value of the card from the purchasing customer. Accordingly, the prepaid value of the card is cash that has been entrusted to and is initially in the physical possession of the merchant. However, this prepaid value belongs to the customer to cover future purchases using the card.

This raises several issues, since a given merchant is not necessarily a bank, and may not be sufficiently ethical, reliable, or secure to preserve the cash comprising the prepaid deposit. Conventionally, a courier (e.g., armored truck service) would have to be sent periodically to the merchant to take physical possession of the prepaid value for all cards sold or reloaded by a merchant. The courier would then transport the cash to a secure location maintained by the financial institution(s) associated with the card. Alternatively, the merchant may be issued an invoice (e.g., known as a “Boleto” in Brazil), which can be used to make a cash bank deposit in a holding account associated with the program or platform manager, a third party, or a financial institution such as the card-issuing bank or bank partner. Since the sums of cash may be substantial, this would typically have to be done on a daily or weekly basis.

In an embodiment, a software module is provided (e.g., hosted and/or executed on server(s) 110) which tracks the prepaid value held by a merchant at any given time. For example, the software tracks each purchase and reloading of a prepaid debit card and the value of the cash handed over and associated with the card in the transaction. The software also tracks the merchant at which each prepaid debit card was sold or reloaded. Accordingly, for each merchant, the software is able to monitor how much cash for prepaid debit card purchases and reloads has been collected.

The operator or program manager of the disclosed system and method can issue credit with a specified credit limit to each merchant. The cash collected by the merchant and tracked by the system is counted against the merchant's credit limit. Once the merchant approaches or surpasses its associated credit limit, a courier can be sent to collect the cash and transport it to a secure location used or maintained by the operator of the system or otherwise associated or contracted with the operator. Alternatively, an invoice can be issued to the merchant, requesting remittance of the held value. In this manner, collections are not time-based, but are instead credit-based. Furthermore, this method of collection can further incentivize merchants to promote prepaid debit cards, since the sale or recharging of such cards is equivalent to a loan to the merchant.

The credit limit associated with each merchant can be adjustable. For instance, the software module may track the credit history for each merchant (e.g., collections histories, balances, instances of discrepancies in collections, etc.). The software may automatically apply predetermined rules or algorithms to at least a portion of the credit history of each merchant to determine the initial credit limit allocated to a merchant, as well as whether the credit limit of the merchant should be subsequently adjusted. The rules may be applied periodically or may be applied in response to an update or event in the credit history. For instance, a negative indication in the credit history of a merchant can trigger a decrease in the credit limit associated with the merchant. Conversely, a positive indication in the credit history of a merchant can trigger an increase in the merchant's credit limit. Alternatively, these credit limit adjustments may be performed, either periodically or reactively, manually by a human operator.

In an embodiment, the credit limit can be adjusted based on inventory loss, which can be tracked and/or computed as discussed above. For instance, a software module may automatically raise and/or lower a merchant's credit limit based on the inventory loss tracked or calculated for the merchant. This may be an inverse relationship, such that when the inventory loss for a merchant increases (e.g., above a predetermined or calculated threshold), the credit limit for that merchant is automatically lowered, and, when the inventory loss for a merchant decreases (e.g., below a predetermined or calculated threshold), the credit limit for that merchant is automatically increased. Alternatively, this relationship between inventory loss and credit limit for a merchant may be manually controlled (e.g., by an employee or other agent of the program operator).

In the conventional prepaid wireless phone model, if a merchant fails to pay an invoice on time, the merchant is “deactivated” or disallowed from collecting additional deposits. Such deactivations are an annoyance to consumers who may enter the merchant's location expecting to reload their wireless phone minutes, only to find that the system (e.g., terminal) is unavailable. In addition, such deactivation results in a loss of potential deposits for an acquirer, as well as the loss of potential fees to parties entitled to fees from the sale or reloading of prepaid wireless cards. Advantageously, the disclosed systems and methods for prepaid debit cards minimizes the possibility that a merchant will be deactivated by monitoring and/or adjusting a merchant's credit limit, and issuing an invoice as the merchant approaches the determined credit limit. The issuance of invoices may be triggered (e.g., automatically) based on a predetermined algorithm applied to a merchant's available credit and/or past credit history, or the like.

In an embodiment, a software module (e.g., residing and/or executing on server(s) 110) is provided which automatically or with user intervention activates and/or deactivates merchants (e.g., enables/disables merchants from selling cards and/or reloading deposits) depending on the merchants' credit limits. For instance, if a merchant exceeds its credit limit, the merchant may be automatically deactivated, and, if a deactivated merchant's utilized credit falls below its credit limit, the merchant may be automatically activated. Alternatively, this activation and/or deactivation may be performed manually (e.g., by an employee or other agent of the program operator).

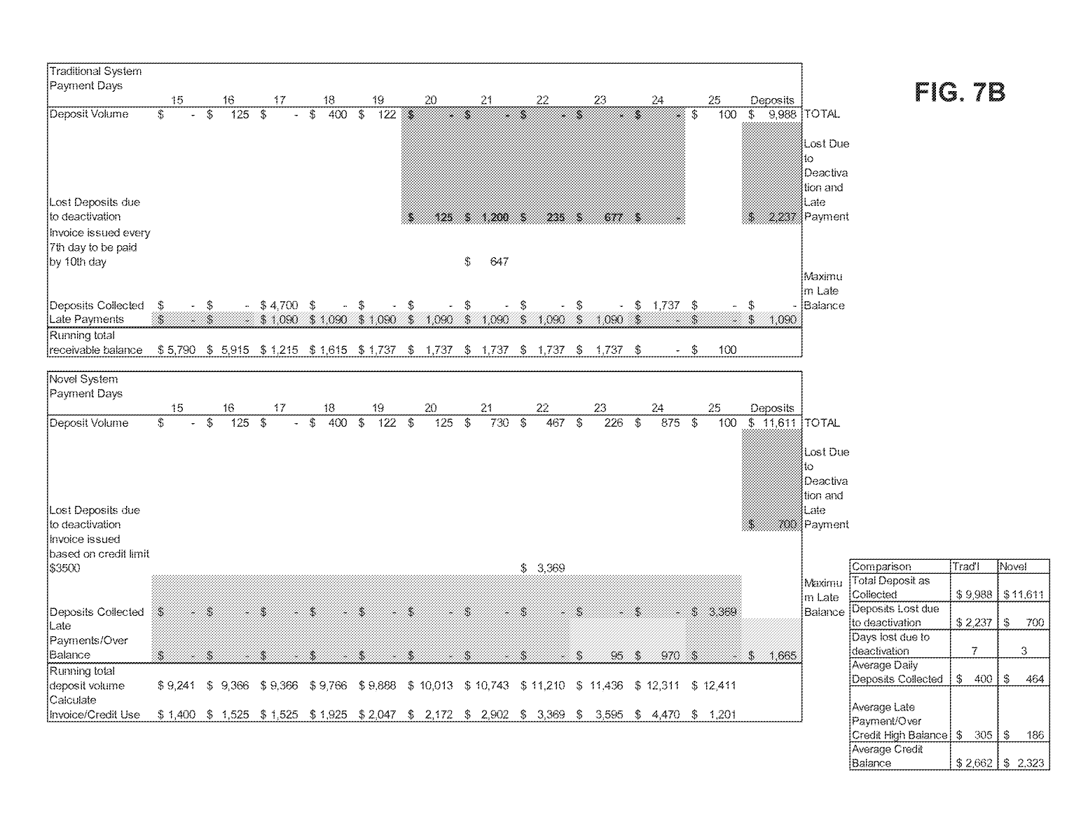

By way of illustration, FIGS. 7A and 7B demonstrate a comparison of a conventional prepaid wireless phone collections model to the novel disclosed model for collections, according to an embodiment. The example conventional system issues invoices every seventh day to be paid by the tenth day, whereas the disclosed system issues invoices based on a credit limit (e.g., $3,500 in this example). As shown, advantageously, the embodiment of the disclosed system results in significantly higher total deposits collected, lower lost deposits due to deactivation, fewer days lost due to deactivation, higher average daily deposits collected, lower late payment/over-credit high balances, and lower average credit balances.

In an embodiment, the operator or program manager of the system can collect revenue in one or more of at least three ways. First, the operator may collect fees associated with the purchase of new cards, maintenance of the card (e.g., monthly or annual fees for maintaining a prepaid debit card), use of the card with an Automated Teller Machine (ATM), and the like. Second, the operator may collect fees associated with funding the card. For example, a fee may be charged every time prepaid value is added to a prepaid debit card. Third, the operator may collect interchange fees. Interchange fees are paid by merchant acquirers (which collect the fees from merchants) when cardholders make purchases using the prepaid debit card. It should be understood that the operator can achieve additional or different revenue generation in other manners, e.g., using different fees. By way of illustration only, in an example embodiment, the purchase price of the prepaid debit cards may range between $4-$6, maintenance of the cards may require a $3.50 monthly fee, reloading the card may require a $3 fee, and withdrawal of funds using the card with an ATM may cost $2.50 per transaction.

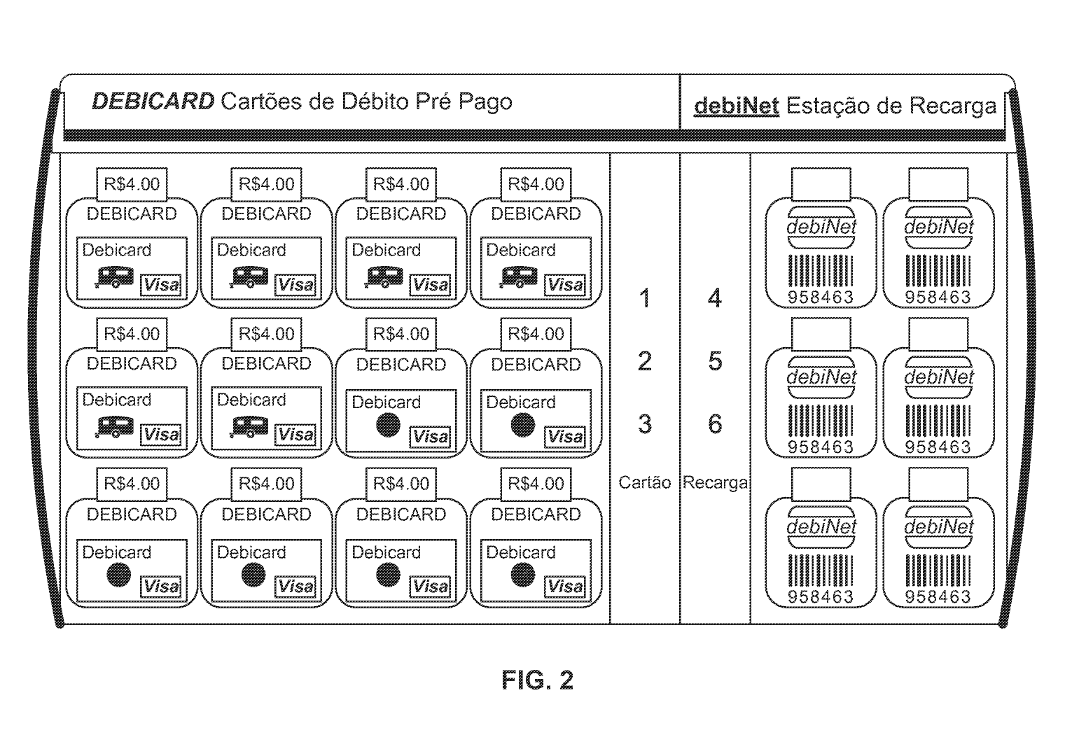

In an embodiment, the prepaid debit cards can be sold and/or reloaded using terminals installed in a merchant location. The terminals can be placed at a point-of-sale within the merchants' locations. For example, the terminal may be placed at or near a checkout counter or cashier's register to increase visibility, but can also be placed at other locations within a merchant location depending on the terms of a contract that is agreed upon with the selling/collecting merchant. FIG. 2 illustrates an example terminal, according to an embodiment. The terminal may comprise hangars and cards hung using the hangars. In this case, the prepaid debit cards are sold just like any other household product.

Alternatively, a terminal may be one of user system(s) 130. As such, the terminal may comprise one or more processors and volatile and/or non-volatile memories, and may have a physical interface (e.g., touch-screen, buttons, cash collection input, etc.) for interacting with consumers. The terminal may also have a network interface or other communications interface to a back-office system, comprising one or more servers for processing and monitoring transactions using the terminal. The terminal may also comprise one or more software modules, for example, stored in the memory of the terminal. The software modules can enable easy loading and reloading of the prepaid debit cards. In an embodiment, the software modules can also offer customized marketing and promotions to customers at the point of sale. These terminals can be placed as new at a merchant location, or may also consist of existing point-of-sale (“POS”) terminals, which are used to process credits, debits, electronic benefits, mobile phone credits, phone credits, or other electronic transactions. The terminals can be based on well-known technologies, such as magnetic stripes, smart cards, radio-frequency identification (RFID), near-field communication (NFC), and the like, and/or may accept numerical inputs such as used in Personal Identification Number (PIN) based transactions.

Together, the terminals, each located at one of a plurality of merchants' locations, form a regional, national, or international retail reload network that is the first of its kind in the non-bank retail industry. The terminals can provide scalable point-of-sale connectivity with one or more prepaid networks.

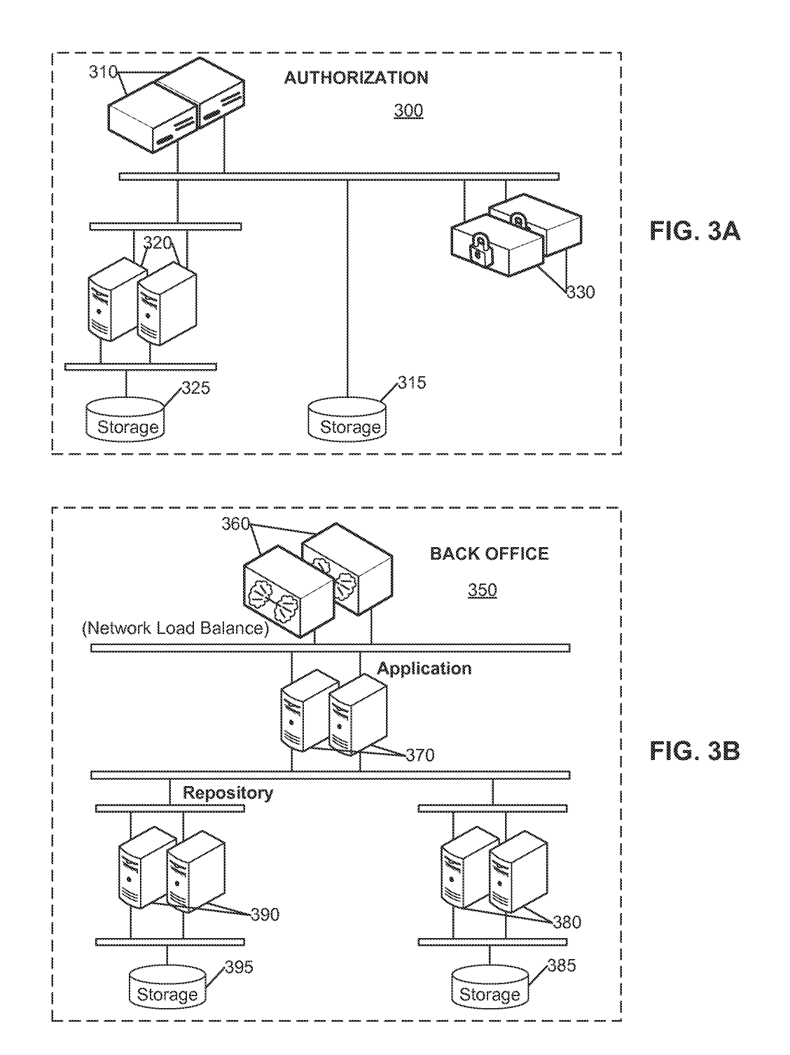

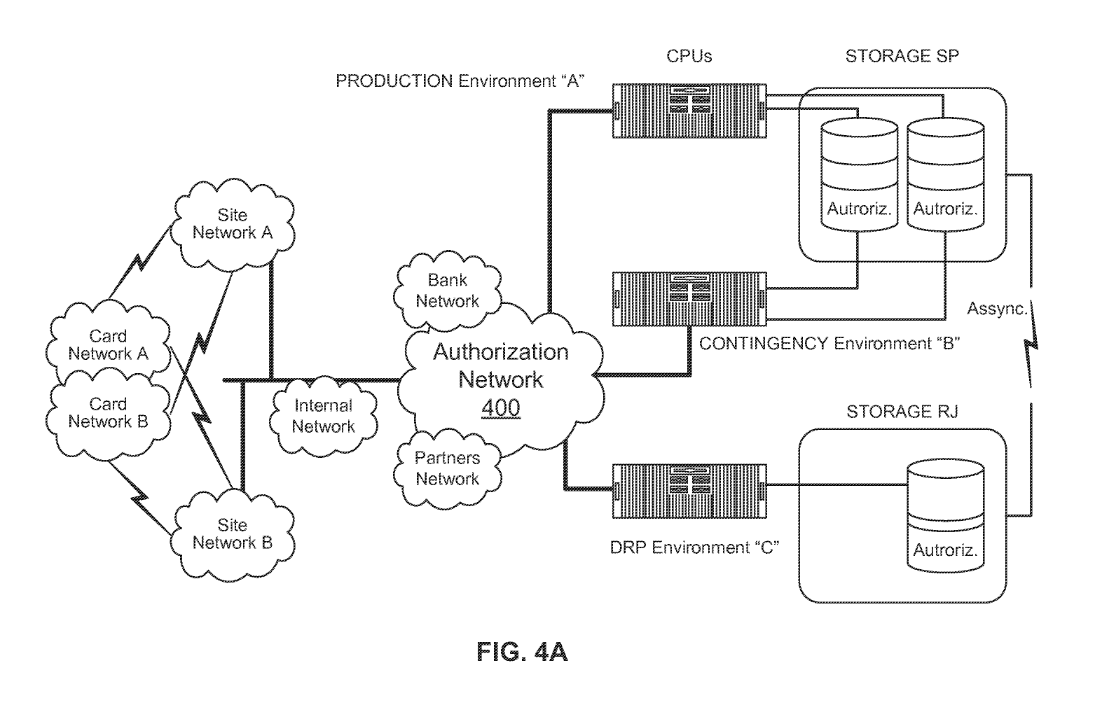

In an embodiment, server(s) 110 may comprise an authorization system and/or a back-office system. FIG. 3A illustrates an authorization system 300, according to an embodiment. The authorization system can perform authentication and implement access restrictions. In an embodiment, the authorization system comprises one or more servers 310, e.g., web servers. The servers may have access to their own dedicated storage 315 (e.g., volatile and/or non-volatile), as well as communicate with one or more database servers 320. The database servers 320 may control and manage one or more databases 325 stored in non-volatile, volatile, or a combination of non-volatile and volatile, memory. The servers 310 may also comprise or be in communication with one or more hardware security modules (HSMs) 330. An HSM is a secure cryptoprocessor that manages digital keys, thereby accelerating cryptoprocesses in terms of digital signings and providing strong authentication for accessing critical keys for server applications. In an embodiment, a second, failover authentication system (not shown) is also provided and periodically automatically synchronized with the first, production authentication system 300 to provide disaster recovery protection or failover service.

FIG. 3B illustrates a back-office system 350, according to an embodiment. The back-office system can perform the primary tasks for the disclosed systems and methods. Access to the back-office system 350 may be controlled and restricted by the authentication system 300, for example, described above in relation to FIG. 3A. In an embodiment, the back-office system 350 comprises load-balancers 360 for distributing traffic among two or more application servers 370. Alternatively, the back-office system 350 may comprise no load-balancing and/or a single application server. In either case, the back-office system 350 can comprise one or more application servers 370 which host and execute one or more applications which implement the disclosed processes. For example, the application(s) may monitor and track prepaid debit card transactions. The application(s) may also monitor and track the credit histories of merchants utilizing the system, and/or automatically adjust the credit limit extended to merchants based on their credit histories, as well as schedule couriers and/or generate and issue invoices. The applications may also reconcile the number fo consignments and the number of sales for a merchant. In an embodiment, the back-office system 350 may also comprise one or more database servers 380. The database servers may control and manage one or more databases 385. The back-office system 350 may also comprise one or more repositories, which may include one or more repository servers 390 and data storage 395. In an embodiment, a second, failover back-office system (not shown) is also provided and periodically automatically synchronized with the first, production back-office system 350 to provide disaster recovery protection or failover service.

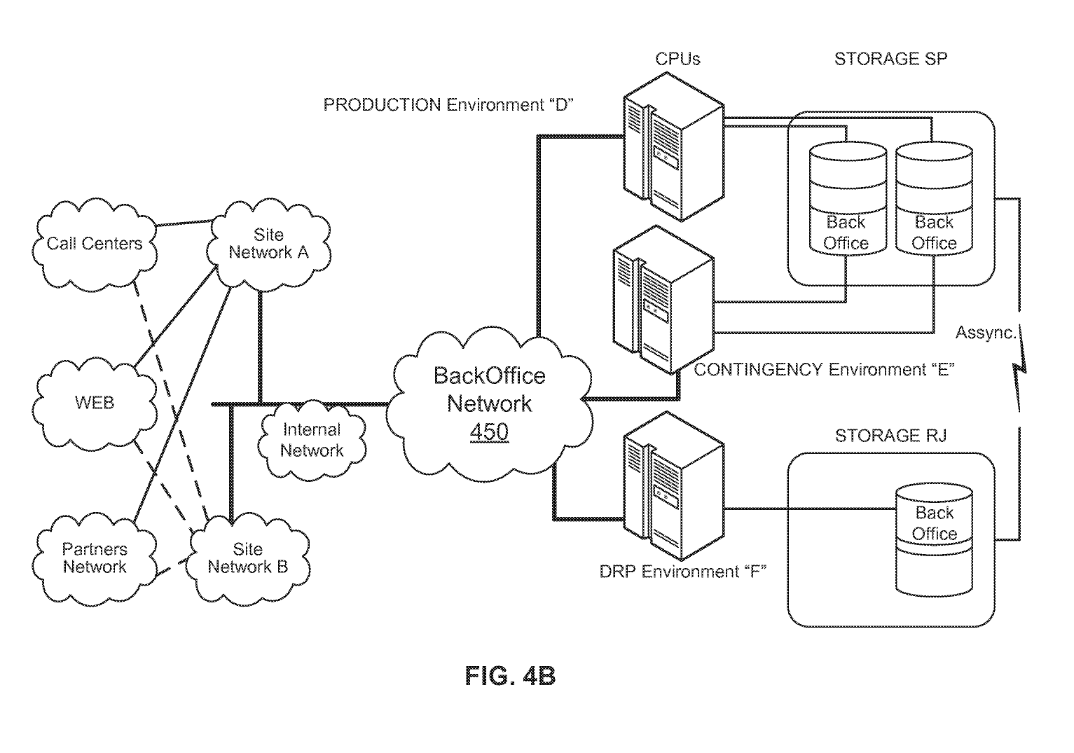

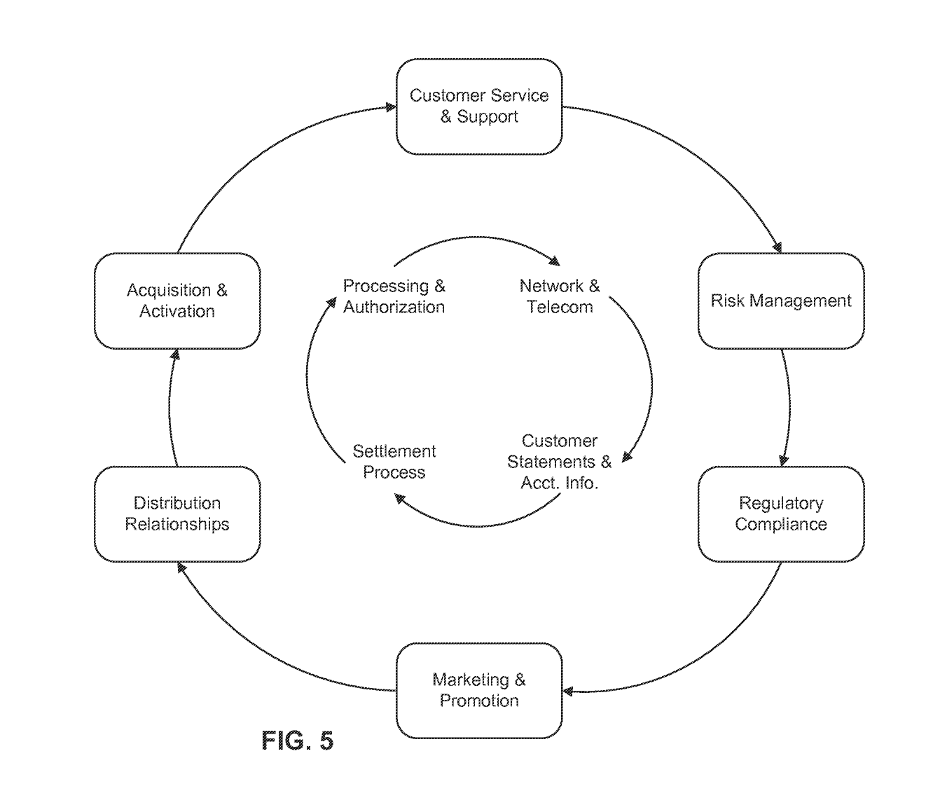

FIG. 4A is a diagram of an authorization network 400, according to an embodiment. The authorization network 400 provides authorization services for embodiments of the disclosed systems and methods, using, for example, the authentication system 300 of FIG. 3A. For instance, as illustrated, the authorization network provides authentication for transaction information received by the disclosed back-office system 350 from payment processors such as Visa™ or MasterCard™ (e.g., through regional networks). The authorization network 400 may also provide authentication for transactions and other interactions with bank networks and/or partner networks. The authorization network 400 may provide failover and disaster recovery by providing access to a contingency and/or disaster recovery environment in the event of a contingency or disaster.

FIG. 4B is a diagram of a back-office network 450, according to an embodiment. The back-office network 450 provides the disclosed processes for merchants, including brick-and-mortar and online merchants, as well as for call centers. Communications with merchants, including transactions and other interactions, can be received and served at the back-office network 450. These communications may be routed through one or more networks between the merchants and the back-office network 450, including the Internet, partner networks, and other networks. The back-office network 450 may provide failover and disaster recovery by providing access to a contingency and/or disaster recovery environment in the event of a contingency or disaster.

There may be multiple parties involved in implementing the prepaid debit card systems and methods disclosed herein. For example, there may be an operator or program manager, which coordinates one or more other parties, including processor(s), issuer(s), distributor(s), and network(s). A processor manages prepaid accounts, network access, customer care, and the like. An issuer may comprise an institutional BIN sponsor, which is a member of a relevant payment network (e.g., Visa, MasterCard, etc.) with rights to issue cards in the market. The BIN sponsor provides access to the card market to a card offeror by allowing the card offeror to use the sponsor's Bank Identification Number (BIN) with its cards. The BIN sponsor can issue the cards and provide license sponsorship, regulatory compliance, float, funds management, etc. A distributor provides marketing to merchants, shelf space, sales services, and the like. A network provides the ability to purchase on a debit/credit network or loan funds onto a card.

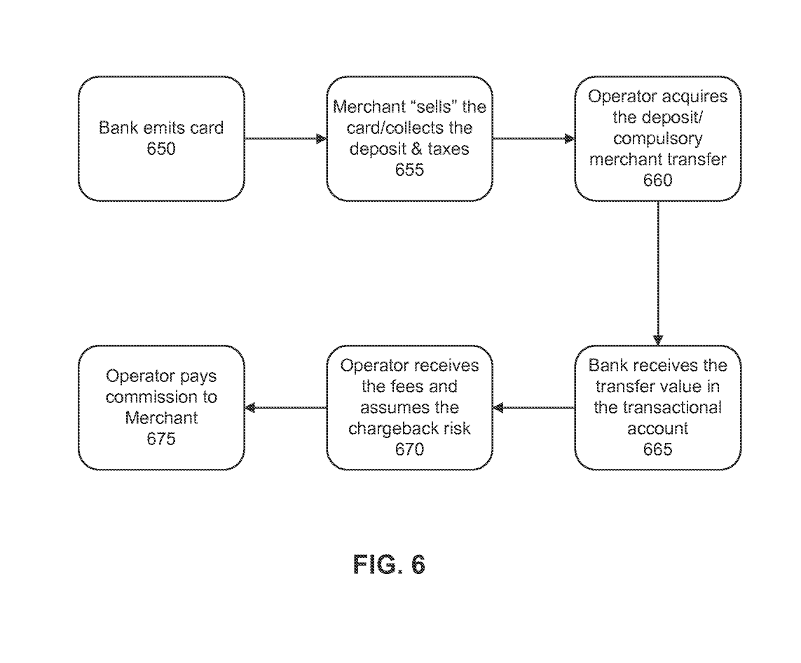

FIG. 5 illustrates a high-level diagram of program management and transaction processing on a scalable technology platform, according to an embodiment.

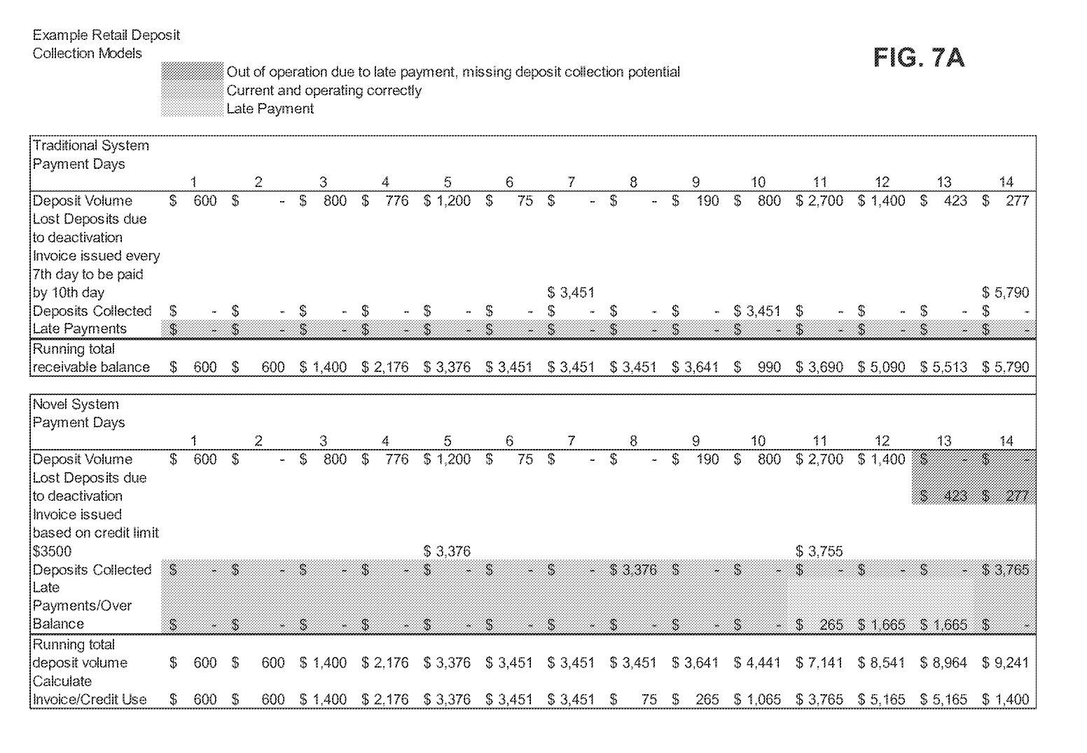

FIG. 6 illustrates a high-level diagram of a monetary model, according to an embodiment. A bank associated with the operator or program manager issues or emits prepaid debit cards (650), which are consigned to a merchant. The merchant sells the cards and collects the prepaid deposit and any fees or taxes (655). The operator then acquires the prepaid deposit merchant through a compulsory transfer (660). The bank receives the transferred prepaid deposit in a transactional account associated with the cards (665). The operator receives fees and assumes chargeback risks (670), and pays a commission to the merchant (675).

Advantageously, as un-banked or under-banked consumers purchase and reload prepaid debit cards, and use their prepaid debit cards transactions, they can be gradually brought into the banking system. These consumers can transfer money, shop, and pay bills without owning a bank account, issuing checks, or waiting in bank lines. Furthermore, these consumers will develop credit histories through controlled spending which can be monitored and tracked, and which may aid the consumers in obtaining bank and credit accounts in the future. These consumers can also experience first-hand the security, convenience, flexibility, and other advantages of using debit cards, and learn the advantages of participating in the banking system, while avoiding credit checks and overdrafts. Accordingly, the disclosed systems and methods can beneficially guide under-banked and un-banked consumers into the banking system, even in traditionally cash-based societies. Moreover, this service can be provided to consumers at tens or hundreds of thousands of locations without the need for any bank branches, and without employing a single bank teller, thereby enabling low-cost, high-margin fees.

In an embodiment, the operator or program manager can issue prepaid debit cards in the form of corporate accounts. These cards can be the same as the prepaid debit cards sold in retail outlets, but can be used by businesses to electronically emit payroll deposits. For instance, a business can emit payroll deposits directly to an account associated with a new prepaid debit card or an existing prepaid debit card that has already been issued to an employee. Employers and employees can obtain diverse benefits on the corporate cards, including a reduction in operating costs for payroll, management improvement tools, an increase in employee satisfaction, and other benefits, as discussed above.

Such corporate prepaid debit cards can be used, for example, in Brazil's “Meal Ticket” program. In Brazil, the largest operator in this ticket program has more than 53,000 registered businesses and 5.3 million accounts held in the electronic benefits system. It is part of a closed-loop system that allows the account holder to user their credits in one of 280,000 registered restaurants in their specific benefits network. The infrastructure is completely autonomous to the primary credit and debit processing system, and has significant implementation and maintenance costs. Existing accounts are based on a tax incentive that the government credits worth 50% of benefits deposited for meals for employees in a company's account. Therefore, the company will obtain a tax credit upon paying this benefit as a salary. In an embodiment, corporate prepaid debit cards can be loaded using electronic benefits transfer. Employees using the corporate prepaid debit cards will have the freedom to buy desired products, services, or meals, because they will have access to an open payment network such as Visa™ or Mastercard™, instead of being limited to only selected restaurants participating in other programs. Employees may also have all the benefits of holders of the retail prepaid debit cards, but at an even lower cost, since the associated company or business can pay the fees associated with the cards.

In the future, it is possible that prepaid debit card program operators may contract with third-party merchant acquirers or POS or reload network operators, that own, sell, rent, and maintain networks of POS machines (or other hardware and/or software), in order to activate prepaid debit cards or accept reloads for prepaid debit cards on behalf of the program operator. These merchant acquirers or network operators may have thousands and even hundreds of thousands of POS machines (or other hardware and/or software) deployed which are capable of sending electronic data messages via Internet Protocol (IP) or wireless voice of data channels. For example, these electronic data messages may include, without limitation, card identifier data, consumer personal identification data, activation data, reload data, and/or purchase data.

In an embodiment, incentives can be provided by the program operator/manager to these merchant acquirers or network operators in exchange for accessing their deployed or future networks. It should be understood that these incentives can be managed using the same systems and methods described above with respect to merchants. In this case, the incentives may be divided between the merchant acquirers and/or network operators and the merchants that own, rent, or maintain the POS machines (or other hardware and/or software) that are deployed in their physical locations and enable the prepaid debit card transactions (e.g., sale, activation, reload, and/or purchases). The incentives may be paid to the merchant acquirers and/or POS or reload network operators using the same conditions, rules, processes, and systems described above with respect to merchants. Thus, in embodiments, the disclosed system may automatically divide an incentive between merchants, merchant acquirers, and/or network operators based on any of the methods discussed above, including based on variable or fixed percentages. For example, the percentages can vary depending on the volume or value of the transactions associated with prepaid debit cards sold through the merchant and merchant acquirer's/network operator's POS machines.

In an embodiment, credit limit information for one or more merchants, which may be determined and/or adjusted as discussed above, may be sent to the merchant acquirers and/or POS/reload network operators with whom the program operator has contracted. The credit limit information may be automatically transmitted from a software module of the program operator (e.g., residing and/or executing on server(s) 110) to the relevant merchant acquirer(s) and/or network operator(s) (e.g., periodically, in response to a request or polling from the merchant acquirer or network operator, in response to a change in the credit limit of a merchant, etc.). The merchant acquirer and/or network operator may utilize the received credit limit information to manage its collection procedures for its managed POS machines (or other hardware and/or software deployments).

Example Device

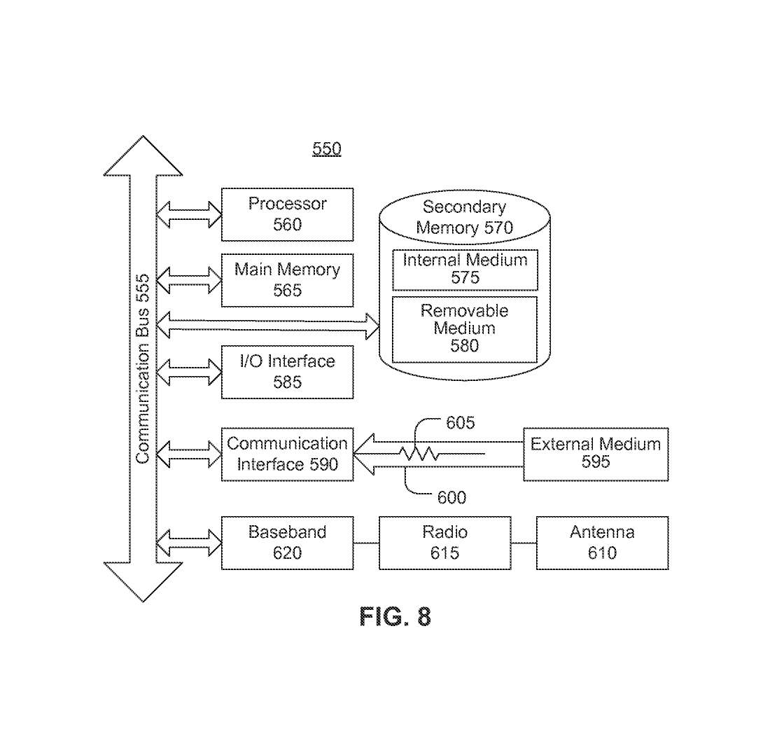

FIG. 8 is a block diagram illustrating an example wired or wireless system 550 that may be used in connection with various embodiments described herein. For example the system 550 may be used as or in conjunction with one or more of the modules or applications, as previously described above. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560, such as one or more of the modules discussed above. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that were previously described with respect to FIGS. 2 and 3.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A method for managing prepaid debit cards, the method comprising:
consigning one or more prepaid debit cards to a merchant;
by at least one hardware processor, receiving transaction information comprising data related to one or more purchase transactions in which the one or more prepaid debit cards were used; and
providing an incentive to the merchant based on the received transaction information.

2. The method of claim 1, wherein the one or more purchase transactions comprise a plurality of purchase transactions.

3. The method of claim 2, wherein the plurality of purchase transactions include at least one of an ATM transaction, a point-of-sale transaction, an online transaction, and a charging or recharging transaction.

4. The method of claim 2, further comprising tracking the plurality of purchase transactions for the life of the one or more prepaid debit cards and determining the incentive based thereon.

5. The method of claim 2, wherein the incentive comprises a percentage of a monetary value of the plurality of purchase transactions.

6. The method of claim 2, wherein the incentive comprises a fixed value for each of the plurality of purchase transactions.

7. The method of claim 2, wherein the transaction information further comprises one or more fee-based transactions.

8. A system for managing prepaid debit cards, the system comprising:
at least one hardware processor; and
at least one executable software module that, when executed by the at least one hardware processor,
receives an association between one or more prepaid debit cards and a merchant,
receives transaction information comprising data related to one or more purchase transactions in which the one or more prepaid debit cards were used, and
determines a commission amount of the merchant based on the association and the received transaction information.

9. The system of claim 8, wherein the one or more purchase transactions comprise a plurality of purchase transactions.

10. The system of claim 9, wherein the plurality of purchase transactions include at least one of an ATM transaction, a point-of-sale transaction, an online transaction, and a charging or recharging transaction.

11. The system of claim 9, at least one executable software module is further configured to track the plurality of purchase transactions for the life of the one or more prepaid debit cards and determining the incentive based thereon.

12. The system of claim 9, wherein the commission comprises a percentage of a monetary value of the plurality of purchase transactions.

13. The system of claim 9, wherein the commission comprises a fixed value for each of the plurality of purchase transactions.

14. The system of claim 9, wherein the transaction information further comprises one or more fee-based transactions.
